(19) United States
(12) Patent Application Publication
(10) Pub. No.: US 2013/0233868 A1
(43) Pub. Date: Sep. 12, 2013

(54) Produce Washing Bowl

(71) Applicant: Alon Benishai, Brooklyn, NY (US)

(72) Inventor: Alon Benishai, Brooklyn, NY (US)

(73) Assignee: Art and Cook, Brooklyn, NY (US)

(21) Appl. No.: 13/416,800

(22) Filed: Mar. 9, 2012

(51) Int. Cl. A47J 19/00; B65D 25/28

(52) U.S. Cl. 220/661

(57) ABSTRACT

A device for washing and draining food includes a base portion, a draining dam, and optionally a handle. Draining dam is coupled to wall of base and includes a plurality of holes therein for draining liquid. Draining dam includes a front portion and a lip portion, the front portion forming a section of the base and the lip portion enclosing a portion of the internal bowl space to trap food when device is tipped to drain liquid. Device may further include a handle coupled to the base. In use, a user places produce or other food to be drained, washed or soaked into device, adds water to the device, then tips the device to drain off liquid through holes in draining dam. Food is trapped in the draining dam as user tips device, thus allowing food to remain in the device while liquid is drained off through holes.

### TECHNICAL FIELD

This invention relates to a food preparation and server device.

### BACKGROUND OF THE INVENTION

Traditional colanders or strainers are comprised of a plurality of openings covering most or the entirety of the surface of the device. In operation, a strainer is placed in a sink and a user pours a food in liquid, such as boiled pasta, into the strainer to drain the water from the food; alternatively, a food to be washed or rinsed in placed in the device and water is poured over the food to rinse the food and drain through the device. In use of these traditional strainers, the device must always be placed in a sink for straining or washing due to the location of the holes on the bottom surface of the device through which liquid must drain. This requirement for sink placement may be disadvantageous where a user is unable to place the device in a sink, such as when sink space is unavailable. Existing strainers also do not allow for soaking food and subsequently draining the food in the same container; food first needs to be soaked in a solid container, and then poured into a strainer for draining. Nor do existing bowls allow a user to simultaneously soak and rinse food within the same container; a conventional bowl used for rinsing and soaking will cause food to float to the top and spill out of the bowl as the bowl fills with water. Furthermore, existing designs require a user to move the drained items into another container after removal from a sink so that water does not continue to drain from the strainer holes onto a table or other surface.

The present invention solves the existing limitations. The washing bowl contemplated herein allows a user to drain or wash food items in the bowl without having to place the entire bowl in a sink, thereby allowing a user to use sink space for other items. Additionally, the present invention allows a user to place food in the bowl for soaking and then simultaneously or subsequently drain it through the draining dam of the bowl. The present invention also allows a user to drain a food using the bowl and then placing the bowl onto a table service without the need to transfer to a separate container for serving. Additionally, the present invention allows a user to drain food with one hand for rapid draining of liquid, as well as avoids uncontrolled splashing that occurs when a large amount of food and liquid must be transferred to a traditional strainer.

### SUMMARY OF THE INVENTION

An object of the present invention is to provide a washing bowl for produce or similar food products having a draining dam and a handle. In a preferred embodiment, the draining dam is mounted on the bowl and covers a front area of bowl wall and extends over a portion of the interior space of bowl. The draining dam includes a plurality of holes through which liquid can escape when bowl is tipped in direction of draining dam. Another preferred embodiment may further include a handle coupled to bowl at opposite side of bowl to draining dam to allow a user to grip bowl with one hand and tip bowl to drain liquid through the draining dam. The bowl may be constructed of suitable materials such as plastic, stainless steel, rubber or melamine. The draining dam may be constructed of suitable materials such as plastic, stainless steel, or rubber. The handle may alternatively include a rubber gripping surface fixed thereto.

Other objects, advantages, features, properties and relationships of the invention will be obtained from the following detailed description and accompanying drawings which set forth illustrative embodiments that are indicative of the various ways in which the principles of the invention may be employed.

### BRIEF DESCRIPTION OF THE DRAWINGS

FIG. 1 is a top perspective front view of a washing bowl in accordance with one embodiment of the present invention.

FIG. 2 is a rear view of the washing bowl of FIG. 1.

FIG. 3 is a left side view of the washing bowl of FIG. 1.

FIG. 4 is a top view of the washing bowl of FIG. 1.

FIG. 5 is a front view of the washing bowl of FIG. 1.

### DETAILED DESCRIPTION OF THE PREFERRED EMBODIMENT

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

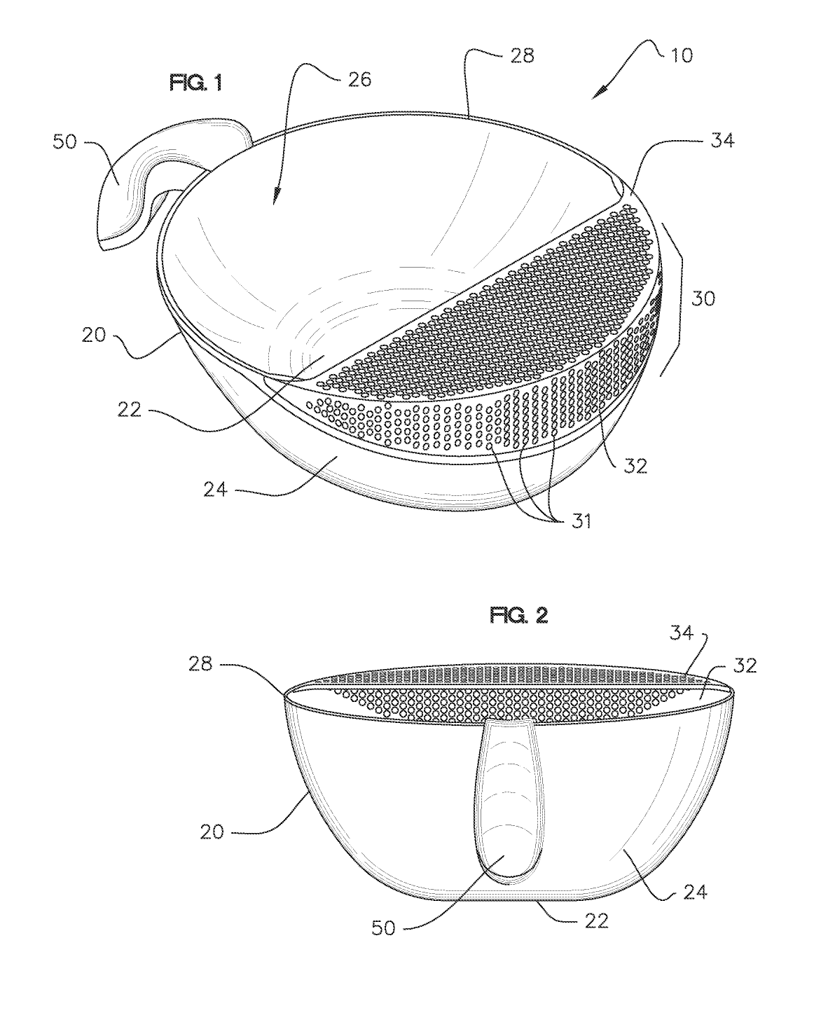

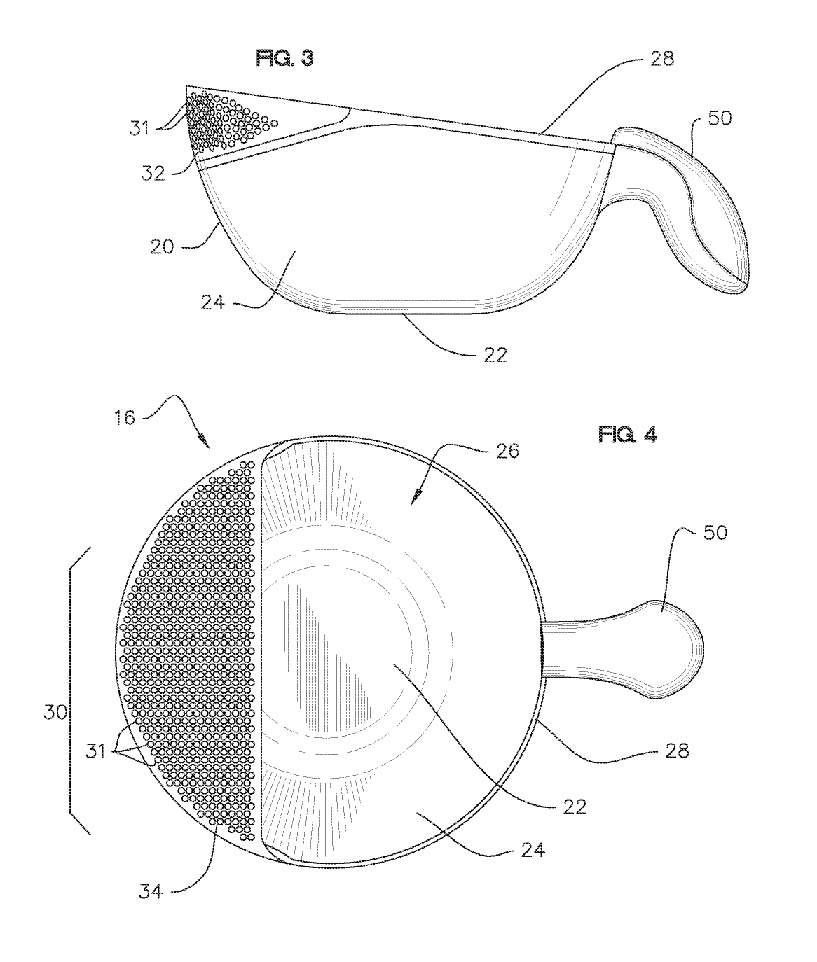

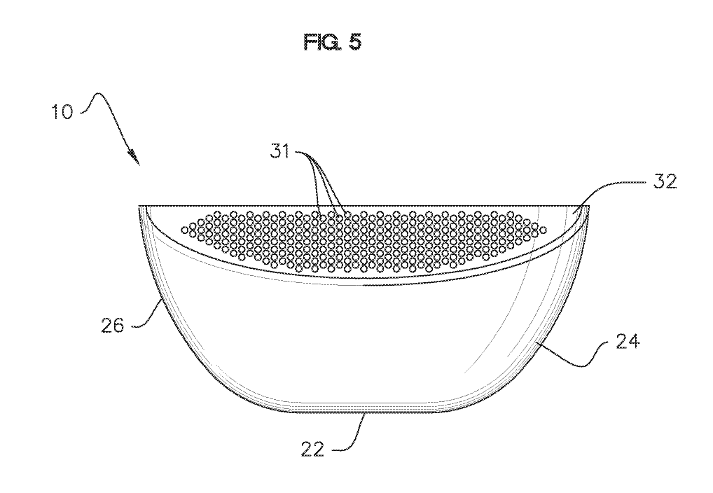

In a preferred embodiment, washing bowl 10 comprises base or bowl portion 20, a draining dam 30, and a handle 50. As shown in FIGS. 1 and 2, base 20 is preferably bowl-shaped, with a flat bottom portion 22 and a rounded wall portion 24. Wall 24 extends upwardly from bottom 22 to define an internal bowl volume or space 26 and a rim 28. Base portion 20 may be constructed of various suitable materials, including plastic and stainless steel. Bowl 10 may alternatively be square or rectangular in shape (not shown) to accommodate various other shapes and sizes of produce, and/or to suit the aesthetic or shape preferences of users.

As seen in FIGS. 1, 2, and 5, a draining dam 30 is coupled to wall 24 of base 20. Draining dam 30 may be coupled to base 20 by based by over-molding the draining dam 30 to the wall 24, or by other suitable means as would be understood by those in the art. Draining dam 30 includes a plurality of holes 31 therein for draining liquid from food. Draining dam 30 comprises a front generally vertical portion 32 and a generally horizontal lip portion 34. Front portion 32 replaces a section of the bowl wall 24 such that liquid can pass through holes 31 in this section. Lip portion 34 is disposed in approximately the same plane as rim 28 and covers a section of the internal bowl space 26. In the preferred embodiment, draining dam 30 thus defines a generally L-shaped space that traps food when bowl 10 is tipped downward to drain liquid through holes 31 in darn 30.

Dam 30 may be comprised of various suitable materials such as plastic, stainless, steel, or rubber. In a preferred embodiment, draining dam 30 is constructed of a rubber material to allow dam 30 to flex slightly when trapping food upon draining liquid. Holes 31 may be of various shapes and sizes, and may vary in number of holes per dam area to accommodate various types of foods.

Washing bowl 10 may optionally include a handle. In the embodiment shown in the FIGS., washing bowl 10 comprises a handle 50. Handle 50 is coupled to base 20 at rim 28 opposite dam 30. Handle 50 may be integrally molded from same material as base 20 where bowl 10 is constructed of plastic or similar materials. Alternatively, where bowl 10 is constructed of another material such as stainless steel, handle 50 may be coupled to base 20 by soldering, screws or other similar and known methods. Handle 50 may alternatively be covered in part by of another material (not shown), such as rubber, to provide an enhanced gripping surface for the user. Handle 50 may optionally further include an indent (not shown) on top portion of handle 50 for placement of a user's thumb, providing for enhanced gripping of the washing bowl 10.

In use, a user places produce or other food to be drained, washed, rinsed or soaked into washing bowl 10. Examples of foods to be washed or rinsed include lettuce, berries, lemons, tomatoes, potatoes, beans, carrots, spinach, mushrooms and the like. User then adds water to the washing bowl 10 to rinse the food. User then grips base 20 (or, where washing bowl 10 includes a handle, user grips handle 50) and tips washing bowl 10 downward to drain off liquid through holes 31 in draining dam 30. Draining dam 30 traps the food in the L-shaped space between front portion 32 and lip portion 34 as user tips washing bowl 10, thus allowing food to remain in the bowl 10 while liquid is drained off through holes 31.

Unlike traditional colanders, where water drains out immediately through holes in the majority of the colander area, water remains in interior space 26 of washing bowl 10 when added. This allows a user to, for example, wipe surfaces of vegetable with a brush or with his/her hands to achieve a more complete wash of the food surface. Additionally, washing bowl 10 allows a user to accomplish the rinsing and draining process without having to place a traditional colander wholly in a sink. Where a traditional colander needs to be placed in a sink prior to rinsing/draining a desired food, washing bowl 10 does not. This provides the advantage of the ability to rinse and drain foods without the user have to clear most of all of his/her sink space. Instead, water can be added to food in washing bowl 10 while on a countertop, and water can simply be poured out into sink without the need to place washing bowl 10 in sink at all.

Other foods that require draining and/or rinsing, such as canned vegetables and beans or cooked pasta in water, can also be drained using washing bowl 10. A user can simply pour the desired food and liquid combination to be drained into washing bowl 10, and tip the excess liquid out through holes 31 of draining dam 30. In the case of cooked pasta to be drained, pouring the food and liquid into a traditional colander and through the plurality of holes often causes a large amount of splashing, which can be dangerous where water is still at or near boiling temperature. Washing bowl 10, which does not have a plurality of holes throughout the base 20 like a traditional colander, reduces the uncontrolled draining and splashing normally encountered.

In addition, unlike traditional colanders or strainers, washing bowl 10 allows a user to soak foods and subsequently drain them in a single container. For example, dry beans, which require soaking before use in cooking, can be soaked in washing bowl 10 and then drained using draining dam 30. This reduces clutter in the kitchen, as well as reduces the number of dishes that require washing. Furthermore, unlike a conventional bowl used for rinsing and soaking food, washing bowl 10 allows a user to simultaneously fill the base 20 with water to soak food and drain excess liquid through the draining dam 30. If using a conventional bowl to rinse and soak food, as the bowl becomes filled with water the food will float to the top and spill over the top rim of the bowl. However, when using washing bowl 10, the draining dam 30 allows water to drain out of the washing bowl 10 while a user fills the washing bowl 10 with water for soaking, preventing over-filling and food spillage.

Another advantage of washing bowl 10 over existing art is that a user can drain off only a portion of liquid from a food. For example, if a user is draining a canned food and wishes to retain some of the liquid that food is canned with, user can pour entire can of food into washing bowl 10 and only drain off the desired amount of liquid. Traditional strainers, with holes throughout the entire surface of the device, do not allow this. Another advantage of washing bowl 10 over existing art is the ability to use a single container to drain cooked pasta and then add clean water to the drained pasta to prevent drying. With a traditional colander or strainer, cooked and drained pasta will become dry after draining off the cooking liquid and leaving the pasta in the colander (or the pasta must be transferred to a conventional bowl or container to add water to prevent drying). When using washing bowl 10, a user can pour cooked pasta into the washing bowl 10 to drain off cooking liquid through draining dam 30, and can then add fresh water to the washing bowl 10 to prevent drying of pasta if additional time is needed before serving.

Another improvement over existing devices is that washing bowl 10 allows a user to serve food in the same container as it is rinsed or drained. Because washing bowl 10 uses draining dam 30 to drain off liquid, rather than holes throughout the base of the container like existing strainers, washing bowl 10 can be used as both a strainer and a serving dish. This reduces clutter in the kitchen, as well as reduces the number of dishes that require washing.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. A device for washing food, the device comprising:
a base comprising:
a generally flat bottom;
a wall extending generally upwardly from the bottom and terminating at a rim, the rim being spaced from the bottom; and
wherein the bottom and wall define an internal space;
and
a draining dam comprising a plurality of holes, the draining dam mounted on to the wall and further comprising:
a generally vertical front portion forming a section of the wall such that liquid can pass through said section of the wall; and
a generally horizontal lip portion extending over a portion of the internal space.

2. The device of claim 1, further including a handle coupled to the base.

3. The device of claim 1, wherein the bottom is circular in shape and the wall extends upwardly around a perimeter of the bottom to define a generally bowl-shaped device.

4. The device of claim 1 wherein the draining dam is mounted to base by over-molding the draining dam on to the wall.

5. The device of claim 2 wherein the handle is located substantially opposite the draining dam.

6. The device of claim 1 wherein the front portion and lip portion are substantially perpendicular.

7. The device of claim 1 wherein the base is comprised of plastic.

8. The device of claim 1 wherein the base is comprised of stainless steel.

9. The device of claim 1 wherein the base is comprised of rubber.

10. The device of claim 1 wherein the base is comprised of melamine.

11. The device of claim 1 wherein the draining dam is comprised of rubber.

12. The device of claim 2 further comprising a gripping surface coupled to the handle.

13. The device of claim 2 further comprising an indent on the top surface of the handle

14. A device for washing food, the device comprising:
a base comprising:
a generally flat bottom;
a wall extending generally upwardly from the bottom and terminating at a rim, the rim being spaced from the bottom; and
wherein the bottom and wall define an internal space;
a draining dam comprising a plurality of holes, the draining dam mounted on to the wall and further comprising:
a generally vertical front portion forming a section of the wall such that liquid can pass through said section of the wall; and
a generally horizontal lip portion extending over a portion of the internal space;
and
a handle coupled to the base.

15. The device of claim 14 wherein the handle is located substantially opposite the draining dam.

16. The device of claim 14 further comprising a gripping surface coupled to the handle.

17. The device of claim 14 further comprising an indent on the top surface of the handle.
